(19) United States
(12) Patent Application Publication
(10) Pub. No.: US 2026/0109063 A1
(43) Pub. Date: Apr. 23, 2026

(54) CUTTER HEAD STRUCTURE

(71) Applicant: NINGBO ICLIPPER ELECTRIC APPLIANCE CO.,LTD, Ningbo (CN)

(72) Inventor: Haoze WU, Ningbo (CN)

(21) Appl. No.: 19/023,445

(22) Filed: Jan. 16, 2025

(30) Foreign Application Priority Data
Oct. 21, 2024 (CN) 2024225401768

(51) Int. Cl. B26B 19/06; B26B 19/38

(52) U.S. Cl. CPC B26B 19/06; B26B 19/3846

(57) ABSTRACT

A cutter head structure, comprising a fixed blade holder, a movable blade holder, a fixed blade, a movable blade and an elastic pressing piece; the fixed blade is fixedly connected to the fixed blade holder, and the movable blade is pressed between the movable blade holder and the fixed blade; the movable blade interacts with the movable blade holder in a linkage manner; a waist-shaped hole is longitudinally formed in a rear end of the elastic pressing piece, and a fastening screw fixedly connected to the fixed blade holder is arranged in the waist-shaped hole; according to the cutter head structure, the movable blade transversely reciprocates relative to the fixed blade, and the longitudinal tooth distance between the movable blade and the fixed blade is conveniently adjusted; the cutter head structure has a simple design, requires few components and is convenient to assemble.

### TECHNICAL FIELD

This invention generally relates to the technical field of electric hair cutters, and more particularly, to a cutter head structure of an electric hair cutter.

### BACKGROUND

Normally, a cutter head of an electric hair cutter not only requires a movable blade to reciprocate transversely relative to a fixed blade for achieving the hair cutting but also requires the movable blade to move longitudinally relative to the fixed blade to change the longitudinal tooth distance between the fixed blade and the movable blade.

Referring to FIGS. 1-2, a conventional cutter head structure of an electric hair cutter comprises a fixed blade holder 1’, a movable blade holder 2’, a fixed blade 3’, a movable blade 4’ and a torsion spring 5. The fixed blade 3’ is fixedly connected to the fixed cutter holder 1’, and a surface of the fixed blade 3’ close to the movable blade 4’ is provided with a guide sliding groove 31’ extending in the transverse direction. A guide sliding block 6’ is arranged in the guide sliding groove 31’, and the movable blade holder 2’ is provided with a blade holder waist-shaped hole 21’. The movable blade 4’ is provided with a blade waist-shaped hole 41’, and the blade waist-shaped hole 41’ extends longitudinally and is configured to correspond to the blade holder waist-shaped hole 21’. A fastening screw 7’ is arranged on the movable blade holder 2’, and the fastening screw 7’ sequentially passes through the blade holder waist-shaped hole 21’ and the blade waist-shaped hole 41’ and is then connected to the guide sliding block 6’, thereby enabling the movable blade 4’ to be fixedly connected to the movable blade holder 2’. The torsion spring 5’ is mounted on the fixed blade holder 1’, and two elastic ends of the torsion spring 5’ act on the movable blade holder 2’, so that the movable blade 4’ is attached to the fixed blade 3’.

In operation, a power device (e.g., a motor) of the electric hair cutter propels the movable balde holder 2’ to move, and the movable blade 4’ transversely reciprocates relative to the fixed blade 3’ through the guiding and limiting interaction between the guide sliding block 6’ and the guide sliding groove 31’, thereby performing the hair cutting. When the longitudinal tooth distance between the movable blade 4’ and the fixed blade 3’ needs to be adjusted, the fastening screw 7’ is unscrewed first, then the movable blade holder 2’ and the movable blade 4’ are pushed in the longitudinal direction until the movable blade 4’ is adjusted to a proper position, and then the fastening screw 7’ is re-tightened. In this way, the adjustment of the longitudinal tooth distance between the movable blade 4’ and the fixed blade 3’ is realized.

However, the aforesaid cutter head structure is complex. For example, to achieve the transverse movement of the movable blade 4’ relative to the fixed blade 3’, the guide sliding block 6’ is arranged, and to achieve the adjustment of longitudinal tooth distance between the movable blade 4’ and the fixed blade 3’, the blade holder waist-shaped hole 21’ and the blade waist-shaped hole 41’ are simultaneously arranged, resulting in high difficulty of assembling the cutter head structure.

Therefore, it is urgent for those skilled in the art to develop a novel cutter head structure.

### SUMMARY

The purpose of the present invention is to provide a cutter head structure, which has a simple structure and is convenient to assemble.

To achieve the above purpose, the present invention adopts the following technical solution: a cutter head structure comprises a fixed blade holder, a movable blade holder, a fixed blade, a movable blade and an elastic pressing piece; the fixed blade is fixedly connected to the fixed blade holder, and the movable blade is pressed between the movable blade holder and the fixed blade; the movable blade interacts with the movable blade holder in a linkage manner; a waist-shaped hole is longitudinally formed in a rear end of the elastic pressing piece, and a fastening screw fixedly connected to the fixed blade holder is arranged in the waist-shaped hole; a front end of the elastic pressing piece presses the movable blade holder, thereby enabling the movable blade to be attached to the fixed blade; moreover, the elastic pressing piece transversely interacts with the movable blade holder in a sliding manner.

In another embodiment of the present invention, the elastic pressing piece comprises a connecting portion, an elastic portion and a pressing portion. The waist-shaped hole is formed in the connecting portion, and the connecting portion is connected to the fixed blade holder through the fastening screw. The elastic portion is connected between the connecting portion and the pressing portion, and the pressing portion presses the movable blade holder.

In another embodiment of the present invention, the elastic portion is configured to be an arched shape and arranged in a direction away from the fixed blade.

In another embodiment of the present invention, the elastic pressing piece comprises the pressing portion arranged at the front end of the elastic pressing piece. The movable blade holder is provided with a sliding groove in the transverse direction. The pressing portion abuts against the interior of the sliding groove, and the pressing portion interacts with the sliding groove in the transverse direction in a sliding manner.

In another embodiment of the present invention, the pressing portion is configured to be U-shaped or V-shaped.

In another embodiment of the present invention, the pressing portion is in clearance fit with a groove bottom of the sliding groove. A front surface of the pressing portion is provided with a front limiting surface that slidably interacts with a front side groove wall of the sliding groove. A rear surface of the pressing portion is provided with a rear limiting surface that slidably interacts with a rear side groove wall of the sliding groove. The pressing portion is limited in the sliding groove through the front limiting surface and the rear limiting surface.

In another embodiment of the present invention, the front limiting surface is in line contact with the front side groove wall of the sliding groove, or the rear limiting surface is in line contact with the rear side groove wall of the sliding groove.

In another embodiment of the present invention, a side wall of a middle portion of the sliding groove is provided with an avoidance notch.

In another embodiment of the present invention, the rear end of the elastic pressing piece is longitudinally provided with a guide hole corresponding to the waist-shaped hole, and the fixed blade holder is provided with a guide protrusion for interacting with the guide hole.

In another embodiment of the present invention, the movable blade is provided with a plurality of positioning holes, and the movable blade holder is provided with a plurality of positioning protrusions in one-to-one correspondence with the positioning holes.

Compared with the prior art, the present invention has the following advantages: according to the cutter head structure of the present invention, a torsion spring and a guide sliding block in the prior art are replaced by the elastic pressing piece having both the elastic pressing function and guiding function; by arranging the waist-shaped hole in the longitudinal direction at the rear end of the elastic pressing piece, the elastic pressing piece is fixedly connected to the fixed blade holder through the interaction between the waist-shaped hole and the fastening screw, thereby enabling the movable blade to transversely reciprocate relative to the fixed blade and allowing the longitudinal tooth distance between the movable blade and the fixed blade to be conveniently adjusted; the cutter head structure has a simple design, requires few components and is convenient to assemble.

### BRIEF DESCRIPTION OF THE DRAWINGS

FIG. 1 is a schematic diagram illustrating the assembly of the cutter head structure in the prior art;

FIG. 2 is a schematic diagram illustrating an explosive view of the cutter head structure in the prior art;

FIG. 3 is a schematic diagram illustrating the assembly of the cutter head structure of the present invention;

FIG. 4 is a schematic diagram illustrating a side view of the cutter head structure of the present invention;

FIG. 5 is a schematic diagram illustrating an enlarged structure of portion A in FIG. 4; and

FIG. 6 is a schematic diagram illustrating an explosive view of the cutter head structure of the present invention.

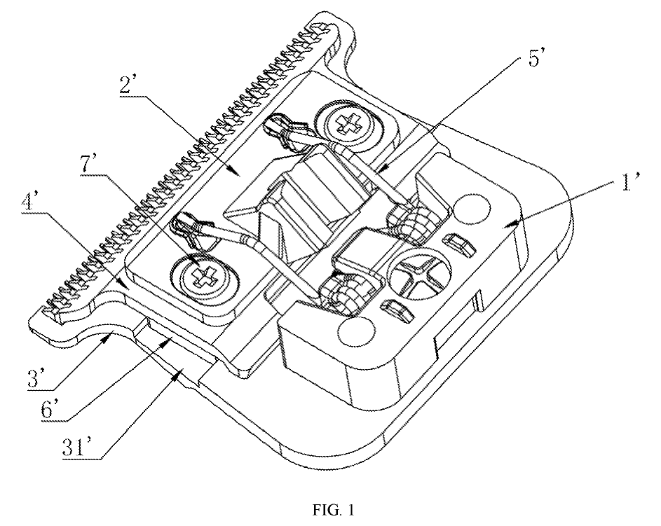

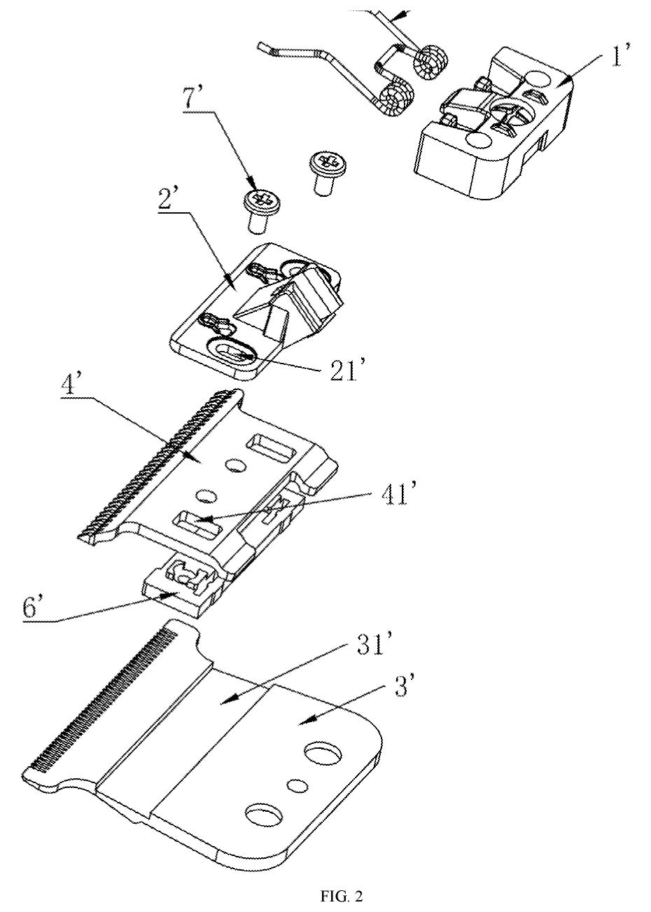

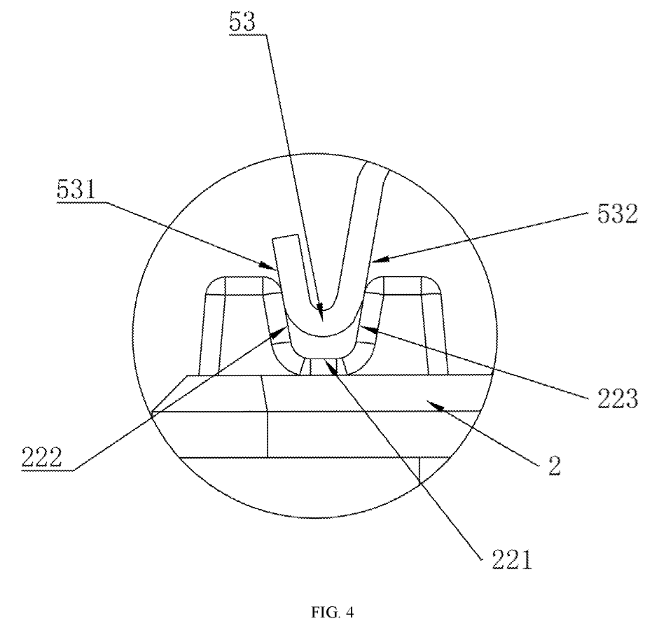

In FIGS. 1-6: 1’-Fixed Blade Holder, 2’-Movable Blade Holder, 21’-Blade Holder Waist-shaped Hole, 3’-Fixed Blade, 31’-Guide Sliding Groove, 4’-Movable Blade, 41’-Blade Waist-shaped Hole, 5’-Torsion Spring, 6’-Guide Sliding Block, 7’-Fastening Screw, 1-Fixed Blade Holder, 11-Guide Protrusion, 2-Movable Blade Holder, 21-Positioning Protrusion, 22-Sliding Groove, 221-Groove Bottom, 222-Front Side Groove Wall, 223-Rear Side Groove Wall, 224-Avoidance Notch, 23-Linkage Portion, 3-Fixed Blade, 4-Movable Blade, 41-Positioning Hole, 5-Elatic Pressing Piece, 51-Connecting Portion, 511-Waist-shaped Hole, 512-Guide Hole, 52-Elastic Portion, 53-Pressing Portion, 531-Front Limiting Surface, 532-Rear Limiting Surface, 6-Fastening Screw.

### DETAILED DESCRIPTION

Drawings are combined hereinafter to further elaborate the technical solution of the present invention.

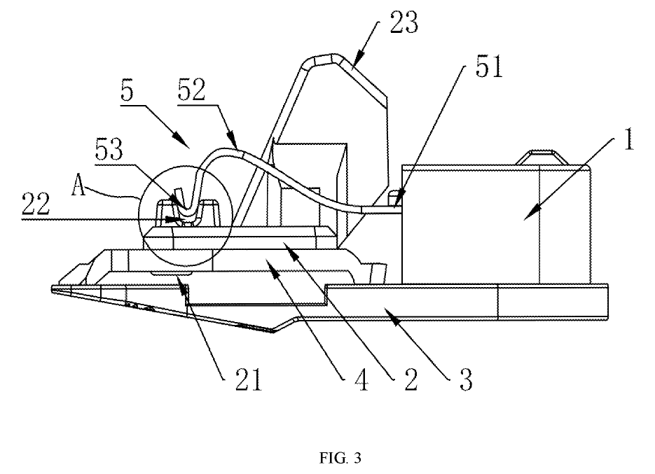

Referring to FIGS. 3-6, the cutter head structure comprises a fixed blade holder 1, a movable blade holder 2, a fixed blade 3, a movable blade 4 and an elastic pressing piece 5. The fixed blade 3 is fixedly connected to the fixed blade holder 1, and the movable blade 4 is pressed between the movable blade holder 2 and the fixed blade 3. The movable blade 4 is provided with a plurality of positioning holes 41, and the movable blade holder 2 is provided with a plurality of positioning protrusions 21 in one-to-one correspondence with the positioning holes 41. The movable blade 4 interacts with the movable blade holder 2 in a linkage manner through the interaction between the positioning protrusions 21 and the positioning holes 41. When the cutter head structure is mounted on the electric hair cutter, a linkage portion 23 arranged on the movable blade holder 2 is in transmission connection with an output end of a power device (e.g., a motor) of the electric hair cutter, and the movable cutter holder 2 is propelled by the power device to act, so that the movable blade 4 transversely reciprocates relative to the fixed blade 3 to realize the hair cutting.

A waist-shaped hole 511 is longitudinally formed in a rear end of the elastic pressing piece 5, and a fastening screw 6 fixedly connected to the fixed blade holder 1 is arranged in the waist-shaped hole 511. A front end of the elastic pressing piece 5 presses the movable blade holder 2, thereby enabling the movable blade 4 to be attached to the fixed blade 3. Further, the elastic pressing piece 5 transversely interacts with the movable blade holder 2 in a sliding manner. Namely, according to the cutter head structure, the elastic pressing piece 5 possesses both the elastic pressing function and guiding function. When the power device of the electric hair cutter propels the movable blade 4 to transversely reciprocate relative to the fixed blade 3 through the movable blade holder 2, the elastic pressing piece 5 not only ensures that the movable blade 4 and the fixed blade 3 remain attached all the time but also guides the transverse movement of the movable blade 4. In addition, when the longitudinal tooth distance between the movable blade 4 and the fixed blade 3 needs to be adjusted, only the fastening screw 6 needs to be unscrewed first, then the movable blade holder 2, the movable blade 4 and the elastic pressing piece 5 are pushed in the longitudinal direction until the movable blade 4 is adjusted to a proper position, and finally the fastening screw 6 is re-tightened. Thus, the adjustment of the longitudinal tooth distance between the movable blade 4 and the fixed blade 3 is realized.

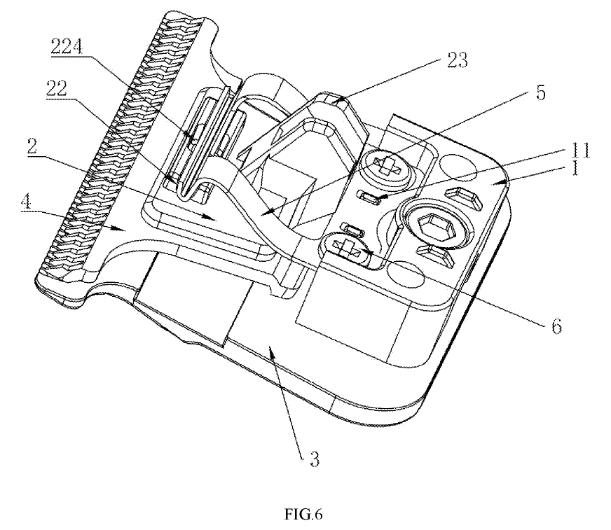

More specifically, in this embodiment, referring to FIG. 6, the projection of the elastic pressing piece 5 on a projection plane parallel to a plane where the fixed blade 3 is located is configured to be a rectangle shape. The elastic pressing piece 5 comprises a connecting portion 51, an elastic portion 52 and a pressing portion 53 that are sequentially arranged from back to front in the longitudinal direction. The waist-shaped hole 511 is formed in the connecting portion 51, and the connecting portion 51 is connected to the fixed blade holder 1 through the fastening screw 6. The elastic portion 52 is connected between the connecting portion 51 and the pressing portion 53, and the pressing portion 53 presses the movable blade holder 2.

Preferably, referring to FIGS. 3, 4 and 6, the elastic portion 52 is configured to be an arched shape and arranged in a direction away from the fixed blade 3. By means of the arched structure of the elastic portion 52, ideal pressing effect of the elastic pressing piece 5 on the movable blade holder 2 is achieved, so that the movable blade 4 is better attached to the fixed blade 3.

Preferably, to realize the transverse sliding interaction between the elastic pressing piece 5 and the movable blade holder 2, the movable blade holder 2 is provided with a sliding groove 22 in the transverse direction. The pressing portion 53 abuts against the interior of the sliding groove 22, and the pressing portion 53 interacts with the sliding groove 22 in the transverse direction in a sliding manner. In this embodiment, to improve the pressing and guiding effect of the elastic pressing piece 5 on the movable blade holder 2, the pressing portion 53 is configured to be U-shaped. Certainly, in other embodiments, as an equivalent replacement, the pressing portion 53 may also be configured to be V-shaped.

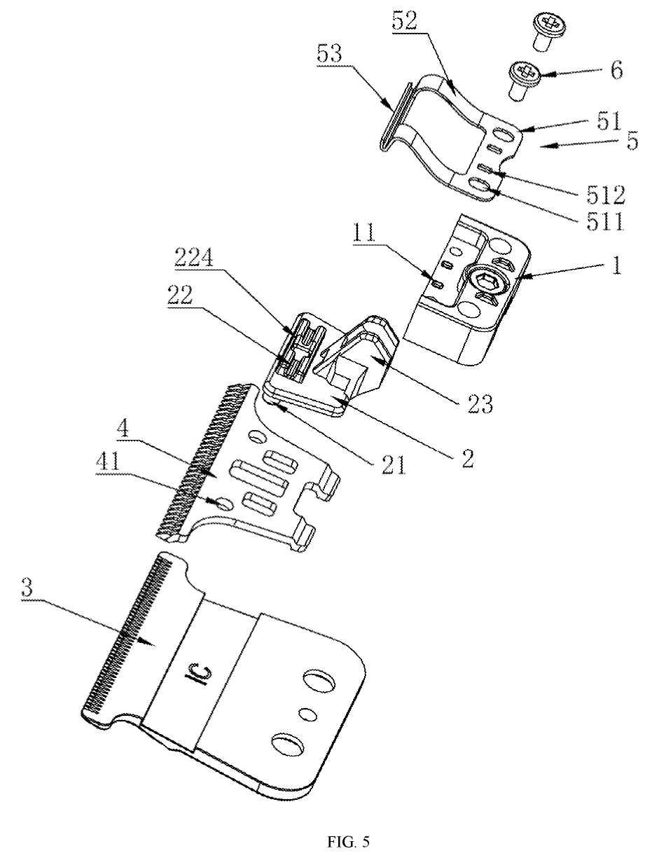

Preferably, to reduce the friction between the elastic pressing piece 5 and the movable blade holder 2 by reducing the contact area between the elastic pressing piece 5 and the movable blade holder 2, referring to FIG. 5, the pressing portion 53 is in clearance fit with a groove bottom 221 of the sliding groove 22. A front surface of the pressing portion 53 is provided with a front limiting surface 531 that transversely slidably interacts with a front side groove wall 222 of the sliding groove 22. A rear surface of the pressing portion 53 is provided with a rear limiting surface 532 that transversely slidably interacts with a rear side groove wall 223 of the sliding groove 22. The pressing portion 53 is limited in the sliding groove 22 through the front limiting surface 531 and the rear limiting surface 532. More specifically, in this embodiment, the front limiting surface 531 is in line contact with the front side groove wall 222 of the sliding groove 22, and the rear limiting surface 532 is also in line contact with the rear side groove wall 223 of the sliding groove 22. By means of the line contact, the friction between the elastic pressing piece 5 and the movable blade holder 2 becomes smaller, so that the frictional damping borne by the movable blade 4 when reciprocating transversely becomes smaller. Thus, ideal hair cutting effect is achieved. Moreover, the pressing portion 53 is in line contact with the sliding groove 22, which achieves low noise when the movable blade 4 moves transversely such that the electric hair cutter operates more quietly. Certainly, in some embodiments, only the front limiting surface 531 is in line contact with the front side groove wall 222 of the sliding groove 22, or only the rear limiting surface 532 is in line contact with the rear side groove wall 223 of the sliding groove 22.

Further, referring to FIGS. 3 and 6, a side wall of a middle portion of the sliding groove 22 is provided with an avoidance notch 224. By means of the avoidance notch 224 arranged in the middle portion of the sliding groove 22, the contact area between the pressing portion 53 and the movable blade holder 2 is further reduced.

Referring again to FIGS. 3 and 6, preferably, in this embodiment, the rear end of the elastic pressing piece 5 is longitudinally provided with a guide hole 512 corresponding to the waist-shaped hole 511, and the fixed blade holder 1 is provided with a guide protrusion 11 for interacting with the guide hole 512. When the longitudinal tooth distance between the movable blade 4 and the fixed blade 3 needs to be adjusted, through the interaction between the guide hole 512 and the guide protrusion 11, the elastic pressing piece 5 is effectively guided, thereby improving the adjustment precision.

According to the cutter head structure of the present invention, a torsion spring and a guide sliding block in the prior art are replaced by the elastic pressing piece 5 having both the elastic pressing function and guiding function. By arranging the waist-shaped hole 511 in the longitudinal direction at the rear end of the elastic pressing piece 5, the elastic pressing piece 5 is fixedly connected to the fixed blade holder 1 through the interaction between the waist-shaped hole 511 and the fastening screw 6, thereby enabling the movable blade 4 to transversely reciprocate relative to the fixed blade 3 and allowing the longitudinal tooth distance between the movable blade 4 and the fixed blade 3 to be conveniently adjusted.

The above are merely preferred embodiments of the present invention, and therefore, equivalent changes or modifications made according to the structure, feature and principle of the present invention shall fall within the scope defined by the claims of the present invention.

What is claimed is:

1. A cutter head structure, comprising:
a fixed blade holder (1),
a movable blade holder (2),
a fixed blade (3),
a movable blade (4), and
an elastic pressing piece (5), wherein the fixed blade (3) is fixedly connected to the fixed blade holder (1), wherein the movable blade (4) is pressed between the movable blade holder (2) and the fixed blade (3), wherein the movable blade (4) interacts with the movable blade holder (2) in a linkage manner, wherein a waist-shaped hole (511) is longitudinally formed in a rear end of the elastic pressing piece (5), wherein a fastening screw (6) fixedly connected to the fixed blade holder (1) is arranged in the waist-shaped hole (511), wherein a front end of the elastic pressing piece (5) presses the movable blade holder (2), thereby enabling the movable blade (4) to be attached to the fixed blade (3), and wherein the elastic pressing piece (5) transversely interacts with the movable blade holder (2) in a sliding manner.

2. The cutter head structure of claim 1, wherein the elastic pressing piece (5) comprises:
a connecting portion (51), an elastic portion (52) and a pressing portion (53), wherein the waist-shaped hole (511) is formed in the connecting portion (51), wherein the connecting portion (51) is connected to the fixed blade holder (1) through the fastening screw (6), wherein the elastic portion (52) is connected between the connecting portion (51) and the pressing portion (53), and wherein the pressing portion (53) presses the movable blade holder (2).

3. The cutter head structure of claim 2, wherein the elastic portion (52) is configured to be an arched shape and arranged in a direction away from the fixed blade (3).

4. The cutter head structure of claim 1, wherein the elastic pressing piece (5) comprises:
the pressing portion (53) arranged at a front end of the elastic pressing piece (5), wherein the movable blade holder (2) is provided with a sliding groove (22) in the transverse direction, wherein the pressing portion (53) abuts against the interior of the sliding groove (22), and wherein the pressing portion (53) interacts with the sliding groove (22) in the transverse direction in a sliding manner.

5. The cutter head structure of claim 4, wherein the pressing portion (53) is configured to be U-shaped or V-shaped.

6. The cutter head structure of claim 4, wherein the pressing portion (53) is in clearance fit with a groove bottom (221) of the sliding groove (22), wherein a front surface of the pressing portion (53) is provided with a front limiting surface (531) that slidably interacts with a front side groove wall (222) of the sliding groove (22), wherein a rear surface of the pressing portion (53) is provided with a rear limiting surface (532) that slidably interacts with a rear side groove wall (223) of the sliding groove (22), and wherein the pressing portion (53) is limited in the sliding groove (22) through the front limiting surface (531) and the rear limiting surface (532).

7. The cutter head structure of claim 5, wherein the pressing portion (53) is in clearance fit with a groove bottom (221) of the sliding groove (22), wherein a front surface of the pressing portion (53) is provided with a front limiting surface (531) that slidably interacts with a front side groove wall (222) of the sliding groove (22), wherein a rear surface of the pressing portion (53) is provided with a rear limiting surface (532) that slidably interacts with a rear side groove wall (223) of the sliding groove (22), and wherein the pressing portion (53) is limited in the sliding groove (22) through the front limiting surface (531) and the rear limiting surface (532).

8. The cutter head structure of claim 6, wherein the front limiting surface (531) is in line contact with the front side groove wall (222) of the sliding groove (22), or the rear limiting surface (532) is in line contact with the rear side groove wall (223) of the sliding groove (22).

9. The cutter head structure of claim 6, wherein a side wall of a middle portion of the sliding groove (22) is provided with an avoidance notch (224).

10. The cutter head structure of claim 1, wherein the rear end of the elastic pressing piece (5) is longitudinally provided with a guide hole (512) corresponding to the waist-shaped hole (511), and wherein the fixed blade holder (1) is provided with a guide protrusion (11) for interacting with the guide hole (512).

11. The cutter head structure of claim 1, wherein the movable blade (4) is provided with a plurality of positioning holes (41), and wherein the movable blade holder (2) is provided with a plurality of positioning protrusions (21) in one-to-one correspondence with the positioning holes (41).
